(19) United States
(12) Patent Application Publication
(10) Pub. No.: US 2014/0036250 A1
(43) Pub. Date: Feb. 6, 2014

(54) MEASURING APPARATUS, LITHOGRAPHY APPARATUS, AND ARTICLE MANUFACTURING METHOD

(71) Applicant: Canon Kabushiki Kaisha, Tokyo (JP)

(72) Inventor: Yoshiyuki Okada, Sakura-shi (JP)

(73) Assignee: Canon Kabushiki Kaisha, Tokyo (JP)

(21) Appl. No.: 13/953,901

(22) Filed: Jul. 30, 2013

(30) Foreign Application Priority Data
Aug. 3, 2012 (JP) 2012-172518

(51) Int. Cl. G01B 7/14; G03B 27/62

(52) U.S. Cl. CPC G01B 7/14; G03B 27/62
USPC 355/75; 702/150

(57) ABSTRACT

The measuring apparatus of the present invention is a measuring apparatus that measures a position of an object based on a first phase signal and a second phase signal which are different in phase from each other. The measuring apparatus includes a generator configured to generate a difference signal indicating a difference between a delay time of the first phase signal and a delay time of the second phase signal based on a variation amount of a phase difference between the first phase signal and the second phase signal, which corresponds to a frequency of at least one of the first phase signal and the second phase signal, and the frequency; and a regulator configured to regulate a sampling timing for at least one of the first phase signal and the second phase signal based on the difference signal.

### BACKGROUND OF THE INVENTION

1. Field of the Invention

The present invention relates to a measuring apparatus, a lithography apparatus, and an article manufacturing method.

2. Description of the Related Art

In recent years, high productivity (throughput) and very fine pattern forming performance (resolution) have been required for lithography apparatuses for use in manufacturing devices such as semiconductor integrated circuits and the like. In such a lithography apparatus, a stage on which an original plate or a substrate is mounted must be positioned accurately at high speed. Thus, a measuring apparatus that is capable of correctly measuring the position of a stage which operates at high speed is required. The positioning accuracy depends on the measurement accuracy of a stage position. For example, an encoder may be used as a unit for measuring the position of a stage which moves at high speed with accuracy of nm or less. An output signal from an encoder consists of two-phase sinusoidal signals (phase A and phase B which are shifted from each other by 90 degrees). The amplitude/offset of each phase signal and the phase difference between two phase signals must be properly regulated. Japanese Patent Laid-Open No. 2002-228488 discloses a method for regulating the amplitude/offset of each output signal and the phase difference between two output signals.

Here, when an encoder is used for measuring the position of a stage which moves at high speed, the frequency of an output signal from the encoder is proportional to a stage moving speed. Thus, when a stage moving speed increases for the improvement in productivity, the frequency of an output signal from the encoder also increases in proportion. On the other hand, since the frequency band of a detection circuit for outputting an output signal from the encoder is finite, the output signal from the encoder is accompanied by a phase delay at a high frequency. Furthermore, the bands (frequency characteristics) of the detection circuits for phase A and phase B may be different from each other due to variation in performance of the components of the detection circuits. Consequently, in the case of high frequency, the phase delay characteristics become different between two detection circuits so that the phase difference between two phases is shifted from 90 degrees. Note that a shift in the phase difference between two phases may occur due to the difference in cable length, substrate pattern length, or signal propagation delay time of a digital circuit or an A/D converter according to the signals of the phases. A shift in the phase difference may cause an error in position measurement, resulting in a reduction in positioning accuracy.

### SUMMARY OF THE INVENTION

The present invention provides, for example, a measuring apparatus advantageous in compensating for a variation in a phase difference between multiphase signals.

According to an aspect of the present invention, a measuring apparatus that measures a position of an object based on a first phase signal and a second phase signal which are different in phase from each other, the measuring apparatus is provided that includes a generator configured to generate a difference signal indicating a difference between a delay time of the first phase signal and a delay time of the second phase signal based on a variation amount of a phase difference between the first phase signal and the second phase signal, which corresponds to a frequency of at least one of the first phase signal and the second phase signal, and the frequency; and a regulator configured to regulate a sampling timing for at least one of the first phase signal and the second phase signal based on the difference signal.

Further features of the present invention will become apparent from the following description of exemplary embodiments with reference to the attached drawings.

### BRIEF DESCRIPTION OF THE DRAWINGS

FIG. 1 is a diagram illustrating a configuration of an exposure apparatus according to one embodiment of the present invention.

FIG. 2 is a diagram illustrating a configuration of a computation unit according to one embodiment of the present invention.

FIG. 3 is a diagram illustrating a configuration of a correction signal generator according to one embodiment of the present invention.

FIG. 4 is a diagram illustrating a configuration of a first generator and a second generator.

FIG. 5 is a diagram illustrating a configuration of a correction computation unit according to one embodiment of the present invention.

FIG. 6 is a diagram illustrating a configuration of a measurement computation unit according to one embodiment of the present invention.

FIG. 7 is a diagram illustrating examples of a detection signal prior to correction and an ideal signal.

FIG. 8 is a diagram illustrating a configuration of an I/V converter according to one embodiment of the present invention.

FIG. 9A is a diagram illustrating a signal waveform in which a fixed phase difference is corrected according to one embodiment of the present invention.

FIG. 9B is a diagram illustrating a signal waveform when a delay time occurs in the phase B signal of the signal shown in FIG. 9A.

FIG. 10A is a diagram illustrating a detection signal waveform according to one embodiment of the present invention.

FIG. 10B is a diagram illustrating the characteristics of a measurement error according to one embodiment of the present invention.

FIG. 11 is a diagram illustrating the characteristics of a phase shift with respect to a frequency.

### DESCRIPTION OF THE EMBODIMENTS

Hereinafter, preferred embodiments of the present invention will now be described with reference to the accompanying drawings.

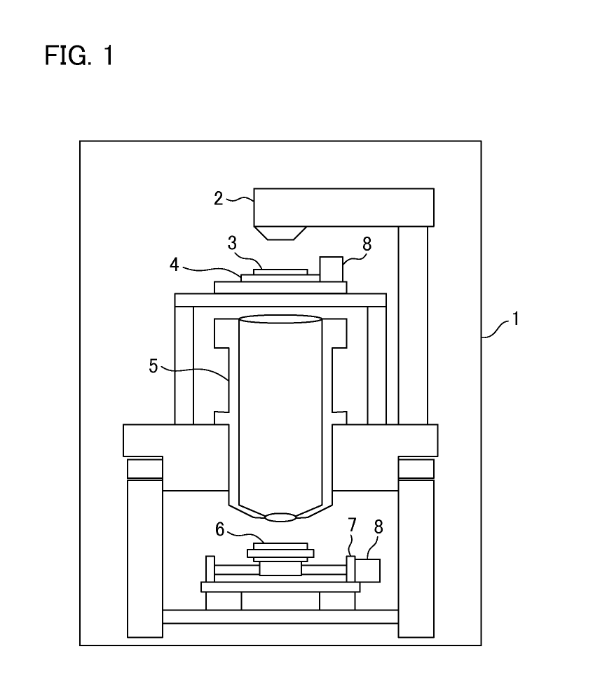

Firstly, a description will be given of an exposure apparatus as an exemplary lithography apparatus to which the present invention is applied. FIG. 1 is a schematic diagram illustrating a configuration of an exposure apparatus 1. The exposure apparatus 1 of the present embodiment is a projection type exposure apparatus that exposes a pattern formed on a mask (original plate) using a step-and-scan system or a step-and-repeat system onto a glass plate (substrate), i.e., a substrate to be treated. Firstly, the exposure apparatus 1 includes an illumination optical system 2, a reticle stage 4 that holds a reticle 3, a projection optical system 5, a wafer stage 7 that holds a wafer 6, and a measuring apparatus (measurement head) 8.

The illumination optical system 2 includes a laser oscillation device (not shown) serving as a light source section, and is a device that illuminates the reticle 3 to be described below on which a transfer circuit pattern is formed. Here, examples of a laser that can be used as a light source include an ArF excimer laser with a wavelength of about 193 nm, a KrF excimer laser with a wavelength of about 248 nm, an F2 excimer laser with a wavelength of about 157 nm, and the like. The type of laser is not limited to an excimer laser, and for example, a YAG laser may also be used. The number of lasers is also not limited. In addition, when the light source section utilizes a laser, a light beam shaping optical system that shapes a parallel light flux from the laser oscillation device into a desired beam shape or an incoherent optical system that makes a coherent laser incoherent is preferably used. Furthermore, a light source available for the light source section is not limited to a laser, but a single or a plurality of lamps such as a mercury lamp or a xenon lamp and an extreme ultraviolet light source may also be used.

The reticle 3 is, for example, an original plate made of quartz glass. The circuit pattern to be transferred is formed on the reticle 3. Also, the reticle stage (original plate holder) 4 is a stage device that is supported on a reticle stage guide (not shown) so as to be movable in the XY direction and holds the reticle 3 by suction via a reticle chuck (not shown).

The projection optical system 5 projects and exposes the pattern on the reticle 3, which has been illuminated with exposure light from the illumination optical system 2, onto the wafer 6 with a predetermined magnification (e.g., ¼ or ⅕). As the projection optical system 5, an optical system consisting only of a plurality of optical elements or an optical system (catadioptric optical system) consisting of a plurality of optical elements and at least one concave mirror can be employed. Alternatively, as the projection optical system 5, an optical system consisting of a plurality of optical elements and at least one diffractive optical element such as a kinoform, an entire mirror type optical system, or the like can also be employed. Note that a reticle stage guide (not shown) and the projection optical system 5 are supported on a barrel surface plate (not shown) mounted on the floor (base surface).

The wafer 6 is a substrate to be treated made of single crystal silicon or the like. A resist (photoresist) is applied to the surface thereof. A wafer stage (substrate holder) 7 is a stage that is movable in the three-dimensional direction and includes a fine movement stage and a coarse movement stage (both not shown). The fine movement stage is a stage that is finely drivable in each direction of x, y, z, cox, coy, and oz and holds the wafer 6 by suction via a wafer chuck (not shown). The coarse movement stage is a stage that is drivable in each direction of x, y, and oz while holding the fine movement stage and is installed on the stage surface plate mounted on the floor.

The measuring apparatus 8 is, for example, an encoder measurement head. It is preferable that the measuring apparatus 8 is attached to a stage (the reticle stage 4 or the wafer stage 7) that moves with the reticle 3 or the wafer 6. Also, the encoder has a scale in which elements for generating a signal required for measuring the position of a measurement object are arranged in spaced-apart relationship with each other, where the scale is read by a measurement head (not shown). The encoder is attached to a stationary member (surface plate or the like) so as to face the measurement head. In FIG. 1, only a measurement head is illustratively shown as the measuring apparatus 8. While, in the present embodiment, a configuration is made such that the measurement head is attached to the stage and the scale is attached to the surface plate, a configuration may also be made such that the measurement head is attached to the surface plate and the scale is attached to the stage. It is also contemplated that an interferometer is generally employed as a position measuring apparatus. The interferometer measures the position of a measurement object by detecting interference light of reflected light obtained by irradiating a mirror with laser light, whereas the encoder measures the position of a measurement object by detecting interference light of diffracted light obtained by irradiating the scale lattice pattern with light. In general, variation in temperature, humidity, and pressure in each optical path between a light illumination unit and a detection unit, which are provided in each measuring apparatus, and a mirror or a lattice pattern results in a change in refractive index, resulting in the occurrence of error in position measurement. The error becomes small as the optical path becomes short. Thus, an encoder in which a light illumination unit and a light detection unit and a mirror or a lattice pattern can be arranged to be close to each other can perform position measurement with higher accuracy than that of an interferometer.

Also, the exposure apparatus 1 includes an alignment detection system that performs positioning of the wafer 6, a transfer system that carries the reticle 3 or the wafer 6 in and out of the exposure apparatus 1, and a control device (not shown). The alignment detection system has an alignment scope and a focus sensor (both not shown). The alignment scope is a measuring apparatus that measures a shift in position of the wafer 6 or the like in the x and y directions. The focus sensor is a measuring apparatus that measures the position of the wafer 6 or the like in the z direction. As in those described above, the exposure apparatus 1 also has a reticle alignment detection system (not shown) that performs positioning of the reticle 3.

The transfer system has a reticle transfer system that carries in/out the reticle 3 and a wafer transfer system that carries in/out the wafer 6. The reticle transfer system has a first transfer robot and a second transfer robot that perform transfer between a reticle Pod which is placed on a predetermined reticle entrance and the reticle stage 4. Here, the reticle Pod is a carrier that holds a plurality of reticles 3 in the interior thereof. The wafer transfer system has a third transfer robot and a fourth transfer robot that perform transfer between a wafer carrier which is placed on a predetermined wafer entrance and a substrate stage. Here, the wafer carrier is a carrier that holds a plurality of wafers 6 in the interior thereof, such as an FOUP (Front Opening Unified Pod) which is a container including a front door.

The control device is a control unit that controls the operation of the components of the exposure apparatus 1, regulation processing, and the like. The control device (not shown) is configured by a computer, a sequencer, or the like, which is connected to the components of the exposure apparatus 1 via a line, having a storage unit such as a magnetic storage medium or the like. The control device executes control of the components by using a program or a sequence.

Next, a description will be given of exposure processing performed by the exposure apparatus 1. Firstly, the wafer transfer system conveys the wafer 6 to be processed from the wafer carrier to the wafer chuck. Also, the reticle transfer system conveys the reticle 3 to be used for the lot from the reticle Pod to the reticle stage 4. Next, after the reticle 3 has been positioned by the reticle alignment detection system, the reticle 3 is moved to a predetermined position on the projection optical system 5 under the drive from the reticle stage 4. Likewise, after the wafer 6 has been positioned by the alignment detection system, the wafer 6 is arranged at a predetermined position below the projection optical system 5 by driving the substrate stage. Next, the illumination optical system 2 irradiates the reticle 3 with irradiation light. At the same time, the exposure apparatus 1 synchronously drives the reticle stage 4 and the wafer stage 7 at the speed proportional to the magnification ratio of the projection optical system 5 such that a circuit pattern formed on the reticle 3 is transferred to a predetermined position of the wafer 6. Here, in order to transfer a circuit pattern with accuracy, the exposure apparatus 1 reflects the previous results measured by the alignment detection system to a substrate stage drive target value in advance. Then, the exposure apparatus 1 repeats exposure processing by sequentially driving the wafer stage 7 and the reticle stage 4 to thereby transfer the circuit pattern to the entire surface of the wafer 6. In order to improve productivity, each of the reticle stage 4 and the wafer stage 7 needs to be driven at ultra-high speed and the position or speed thereof needs to be controlled with ultra-accuracy for refining exposure.

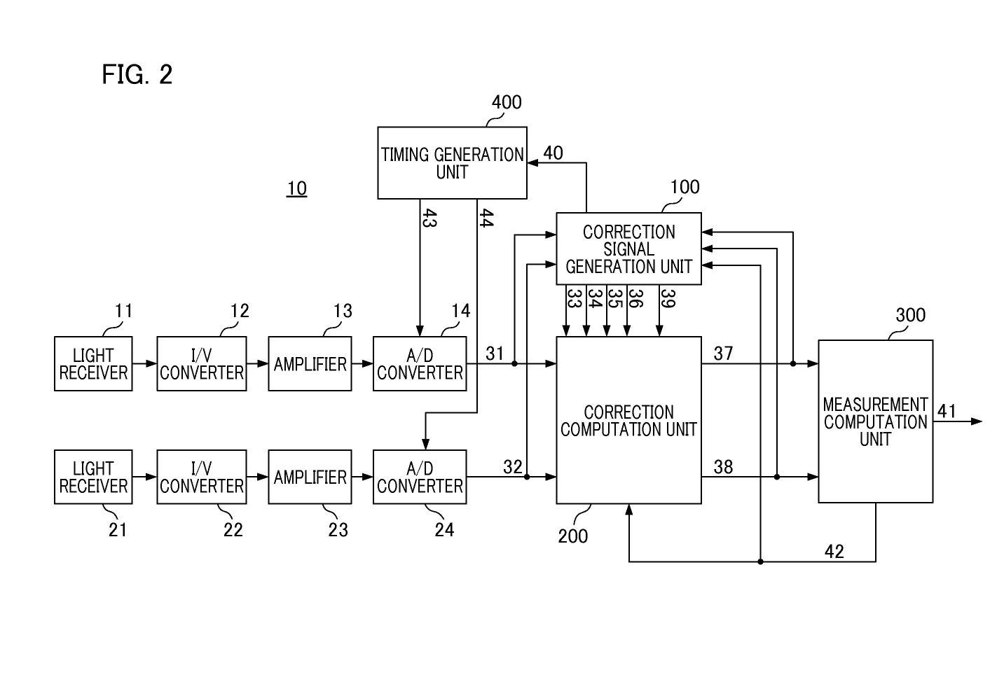

A description will be given of an encoder as an example of a measuring apparatus according to one embodiment of the present invention. The encoder is either a two-phase type encoder in which the phases are different from each other by 90 degrees or a three-phase type encoder in which the phases are different from each other by 120 degrees and detection light is a sinusoidal signal depending on the change in position. Since the basic operation of the two-phase type encoder is the same as that of the three-phase type encoder, a description will be given by taking an example of a two-phase type encoder in the present embodiment. The encoder includes a computation unit (an arithmetic logical unit or a processor) 10 that performs position computation from detection light (signal) of two phases detected by the detection unit. The configuration of the computation unit 10 is shown in FIG. 2. As shown in FIG. 2, the computation unit 10 includes light receivers 11 and 21, I/V converters 12 and 22, amplifiers 13 and 23, A/D converters 14 and 24, and a correction signal generator 100, a correction computation unit (compensation unit) 200, a measurement computation unit 300, and a timing generator 400 each of which serves as a generator.

Firstly, the light receivers 11 and 21 convert signals of two phases detected by the detection unit of the encoder into current. Assume that the signals of two phases which are different from each other are a phase A (first phase signal) and a phase B (second phase signal), the light receiver 11 converts the phase A signal into current and light receiver 21 converts the phase B signal into current. Note that a PIN photo diode, an avalanche photo diode, or the like may also be used as the light receivers 11 and 21. Next, each of the I/V converters 12 and 22 is constituted by a resistance and computation amplifier (OP amplifier). The I/V converters 12 and 22 convert the signals of two phases, which have been converted into current by the light receivers 11 and 12, respectively, into voltage. The I/V converter 12 converts the current from the light receiver 11 into voltage and the I/V converter 22 converts the current from the light receiver 21 into voltage. Next, the amplifiers 13 and 23 amplify the voltage converted by the I/V converters 12 and 22, respectively, to a predetermined voltage. The amplifier 13 amplifies the voltage from the I/V converter 12 and the amplifier 23 amplifies the voltage from the I/V converter 22. Next, the A/D converters 14 and 24 convert the analog signals which have been amplified to a predetermined voltage by the amplifiers 13 and 23, respectively, into digital signals. The A/D converter 14 converts a signal from the amplifier 13 into a digital signal and the A/D converter 24 converts a signal from the amplifier 23 into a digital signal.

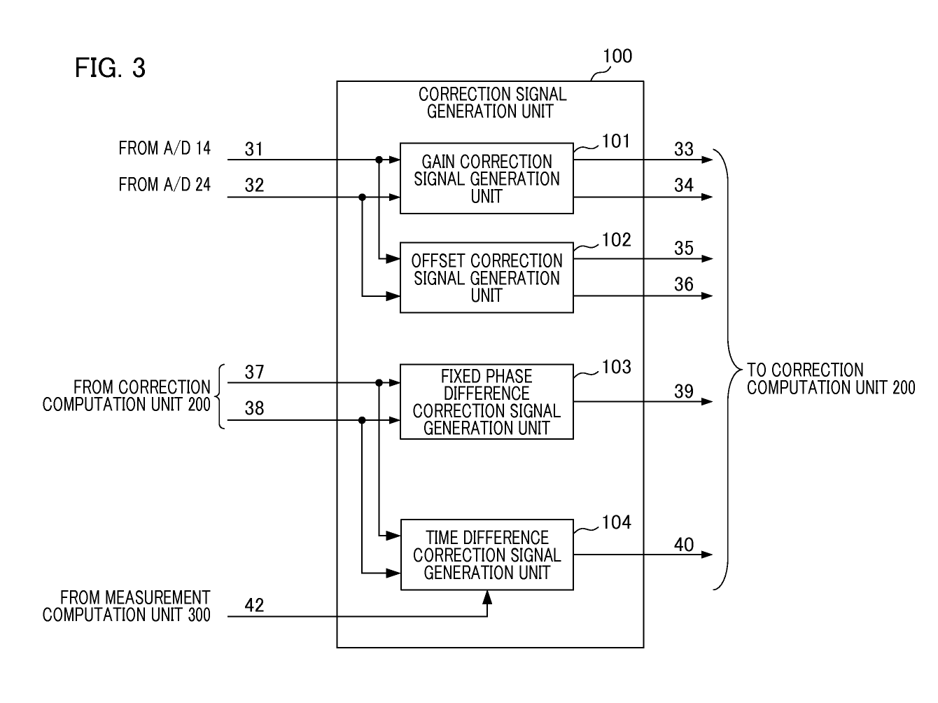

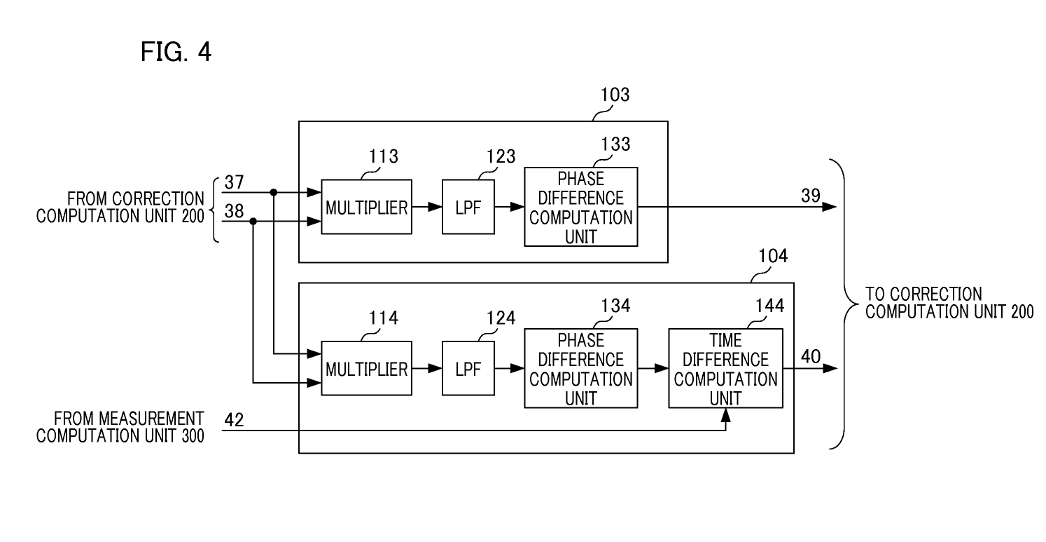

The correction signal generator 100 generates a correction signal from the signals from the A/D converters 14 and 24 and the feedback signals from the correction computation unit 200 and the measurement computation unit 300 to be described below and sends the signal to the correction computation unit 200. The correction signal generator 100 includes a gain correction signal generator 101, an offset correction signal generator 102, a first generator 103, and a second generator 104. The configuration of the correction signal generator 100 is shown in FIG. 3. Firstly, the gain correction signal generator 101 generates a correction signal for correcting gain from the signals output from the A/D converters 14 and 24, and the offset correction signal generator 102 generates a signal for correcting offset from the signals output from the A/D converters 14 and 24. The first generator (fixed phase difference correction signal generator) 103 includes a multiplier 113, an LPF (Low Pass Filter) 123, and a phase difference computation unit 133. The first generator 103 generates a signal for correcting a fixed phase shift from the signal output from the correction computation unit 200. The second generator (time difference correction signal generator) 104 includes a multiplier 114, an LPF 124, a phase difference computation unit 134, and a time difference computation unit 144. The second generator 104 generates a signal for correcting a phase shift caused by a time difference from the signal output from the correction computation unit 200 and the feedback signal output from the measurement computation unit 300. The configuration of the first generator 103 and the second generator 104 is shown in FIG. 4.

The timing generator (regulator) 400 receives a time difference correction signal that has been generated by a delay time difference computed by the correction signal generator 100 to thereby generate signals 43 and 44 for regulating the sampling timings of the phase A signal and the phase B signal.

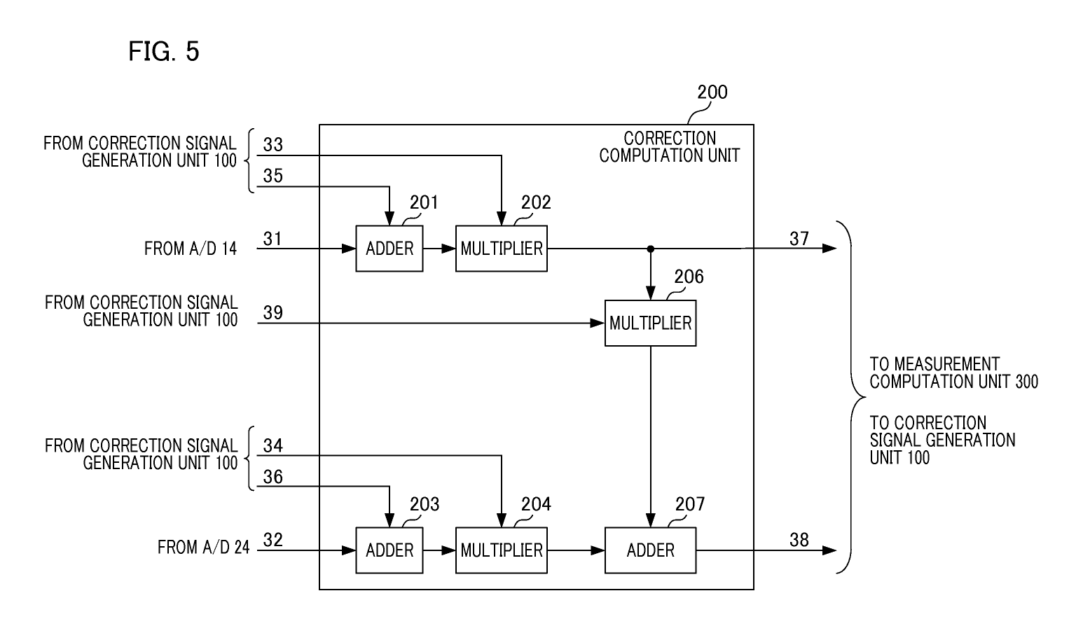

The correction computation unit 200 computes a correction value from the signals output from the A/D converters 14 and 24 and the correction signal generator 100 and the feedback signal output from the measurement computation unit 300, and then sends the computed signal to the correction signal generator 100 and the measurement computation unit 300. As shown in FIG. 5, the correction computation unit 200 includes adders 201, 203, and 207 and multipliers 202, 204, and 206. The configuration of the correction computation unit 200 will be described below in detail.

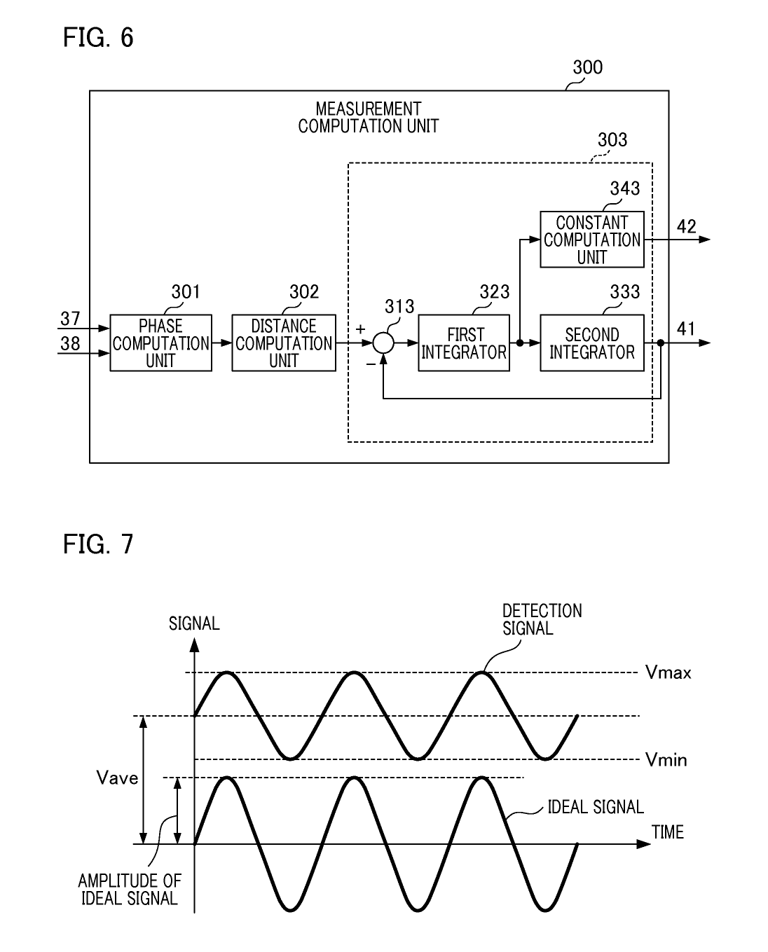

Next, the measurement computation unit 300 calculates the phase state of interference light from the signal of which the offset, gain, fixed phase difference, and variable phase difference have been corrected by the correction computation unit 200 to thereby output the position of a measurement object. Also, the measurement computation unit 300 generates a signal based on the frequency f of the detection signal depending on the moving speed. The measurement computation unit 300 includes a phase computation unit 301, a distance computation unit 302, and a closed loop filter 303. The closed loop filter 303 includes an adder/subtracter 313, a first integrator 323, a second integrator 333, and a constant computation unit 343. The configuration of the measurement computation unit 300 is shown in FIG. 6, and the detail of which will be described below.

Next, a description will be given of the effects of the measuring apparatus of the present embodiment with reference to the drawings. Firstly, as shown in FIG. 3, the correction signal generator 100 generates various correction signals from the signals output from the A/D converters 14 and 24, the correction computation unit 200, and the measurement computation unit 300. The gain correction signal generator 101 generates a correction signal for correcting the signal gain of phase A and phase B to a predetermined value, and the offset correction signal generator 102 generates a correction signal for setting the signal offset to zero. Here, the phase A signal and the phase B signal are represented by the following Formulae (1) and (2), respectively. Note that Formula (3) is an angular velocity formula, where 2πf is an angular frequency corresponding to the frequency f.

A(t)=Va×cos(ωt)+Vosa (1)

B(t)=Vb×sin(ωt+Δθ)+Vosb (2)

ω=2πft (3)

Where Va represents the amplitude of the phase A signal, Vb represents the amplitude of the phase B signal, Vosa represents the offset of the phase A, Vosb represents the offset of the phase B, and Δθ is a fixed phase shift from a phase difference of 90 degrees between the phase A and the phase B. When the position of a portion to be measured is changed for both phases A and B, the amplitude of a detection signal is sinusoidally changed. Here, given that the speed of a measurement object is Vel(m/s), the pitch of a lattice pattern is P(m), the frequency of a detection signal for each of the phases A and B is f (Hz),

f=Vel/P (4)

where the frequency f of a detection signal is proportional to the speed Vel of a measurement object. For example, assume that a detection signal for each of phases A and B is a signal with a period of 1 μm when the pitch of a lattice pattern P is equal to 1 μm and the change in the position of a portion to be measured is 1 μm. When Formula (4) is calculated by using an exemplary case where P=1 μm and Vel=1 m/s, f is equal to 1 MHz.

An example of a detection signal of which the gain and offset are shifted and an ideal signal is shown in FIG. 7. A gain correction signal and an offset correction signal are represented by the following formulas with reference to FIG. 7.

Gain correction signal=amplitude of ideal signal×2/(Vmax−Vmin) (5)

Offset correction signal=Vave=(Vmax+Vmin)/2 (6)

For both phases A and B, gain correction signals 33 and 34 and offset correction signals 35 and 36 are generated by using Formula (5) and Formula (6), respectively. The generated correction signals 33 to 36 are input to the correction computation unit 200.

Next, as shown in FIG. 5, the offset of a signal 31 from the A/D converter 14 is corrected to zero by the offset correction signal 35 and the adder 201 and the gain of the signal 31 from the A/D converter 14 is corrected to a predetermined value by the gain correction signal 33 and the multiplier 202. In this manner, a phase A signal 37 of which the offset and gain are corrected is output. Likewise, the offset of a signal 32 from the A/D converter 24 is corrected to zero by the offset correction signal 36 and the adder 203, and the gain of the signal 32 from the A/D converter 24 is corrected to a predetermined value by the gain correction signal 34 and the multiplier 204. In this manner, a phase B signal 38 of which the offset and gain are corrected is output. A description of the adder 207 will be described below.

Next, the first generator 103 generates a signal for correcting a fixed phase shift, i.e., Δθ in Formula (2) to zero with reference to FIG. 4. The phase A signal 37 and the phase B signal 38 input from the correction computation unit 200 are multiplied by the multiplier 113, and then a direct current component is extracted by the LPF 123. In other words, the phase A signal in Formula (1) and the phase B signal in Formula (2), of which the amplitude is corrected to a predetermined value V and the offset is corrected to zero, are multiplied, and the product of the phase A signal and the phase B signal is represented by the following formula.

$$\begin{matrix}A ( t ) \times B ( t ) = V \times cos ( ω t ) \times \{ V \times sin ( ω t + Δθ ) \} \\ = - {V}^{2} / 2 \times sin ( - Δθ ) + {V}^{2} / 2 \times sin ( 2 ω t + Δθ )\end{matrix} \qquad ( 7 )$$

The first term on the right side of Formula (7) is a direct current signal correlated to a fixed phase shift AO, and the second term is a frequency component twice as high as the frequency f of a detection signal. The direct current component Vdc on the first term is extracted by the LPF 123.

Vdc=−V²/2×sin(−Δθ) (8)

The fixed phase shift AO is calculated by the phase difference computation unit 133 using Formula (8) to thereby obtain a fixed phase difference correction signal 39.

Δθ=sin⁻¹{Vdc/(V²/2)} (9)

When Δθ is a small angle (<<1 rad), Δθ may be approximated by computation within the parenthesis on the right side of Formula (9) without sin⁻¹ computation. Fixed phase difference correction is performed by the correction computation unit 200 using the fixed phase difference correction signal 39.

Next, fixed phase difference correction is performed by the multiplier 206 and the adder 207 shown in FIG. 5. The fixed phase difference correction signal 39 is multiplied by the phase A signal 37 of which the offset and gain are corrected by the multiplier 206 and then the phase A signal of which the amplitude is regulated is added to the phase B signal by the adder 207 to thereby correct the fixed phase shift of the phase B signal. In other words, given that the output of the fixed phase difference correction signal 39 is G,

$$\begin{matrix}B ( t ) + G \times A ( t ) = V \times sin ( ω t + Δθ ) + G \times V \times cos ( ω t ) \\ = {\{ {( V )}^{2} + {( G \times V )}^{2} + 2 \times G \times {V}^{2} \times sin ( Δθ ) \}}^{1 / 2} \times \\ sin [ ω t + {tan}^{- 1} [ \{ G + sin ( Δθ ) \} / cos ( Δθ ) ] ]\end{matrix} \qquad ( 10 )$$

The fixed phase difference correction signal G is added by inverting the sign of Formula (9) such that the term of tan⁻¹ in Formula (10) is zero.

tan⁻¹[{G+sin(Δθ)}/cos(Δθ)]=0 (11)

Since G is sufficiently small as compared with V,

B(t)+G×A(t) becomes approximately equal to V×sin(ωt) (12)

Thus, the fixed phase difference of the output from the adder 207 is corrected to zero. Consequently, the phase B signal 38 of which the offset, gain, and fixed phase difference are corrected is output.

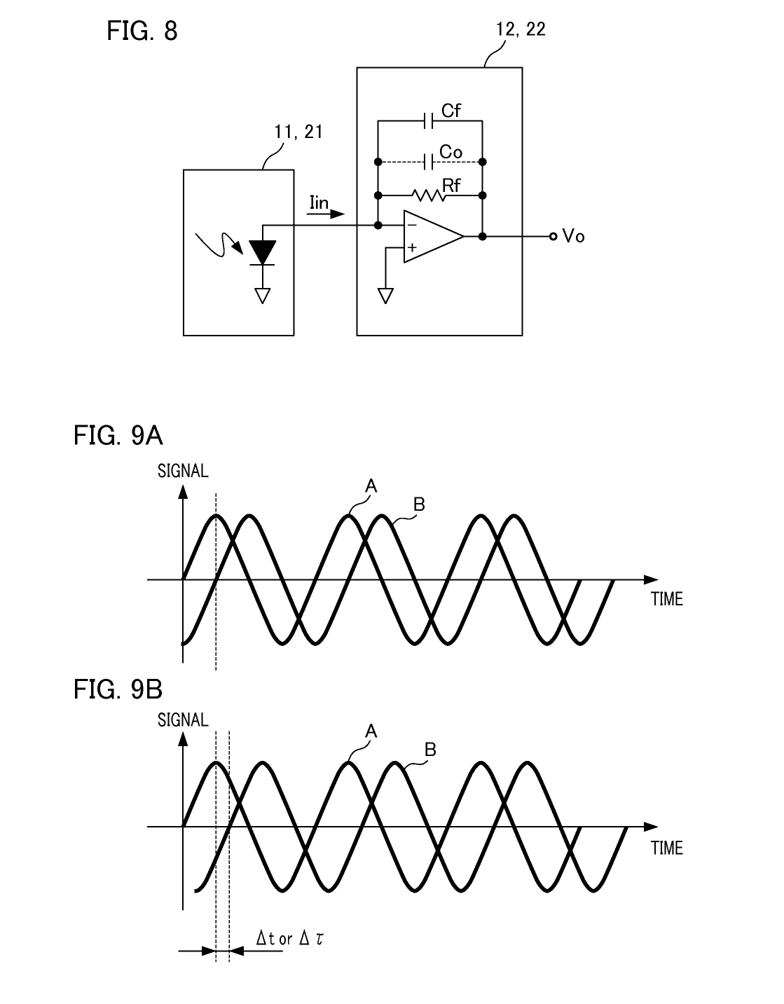

Next, a description will be given of time difference correction. As described above, assume that a detection signal for each of phases A and B is a signal with a period of 1 μm when the pitch of a lattice pattern P is equal to 1 μm and the change in the position of a portion to be measured is 1 μm. In this case, f is equal to 1 MHz when Vel is equal to 1 m/s. An exemplary configuration of the I/V converters 12 and 22 is shown in FIG. 8. Interference light is converted into current Iin by the light receivers 11 and 21, and is converted into voltage V0 by the I/V converters 12 and 22. Here, each of the I/V converters 12 and 22 is constituted by a resistance Rf, a capacitor Cf, and an OP amplifier (computation amplifier). For example, given that a time constant is represented as a primary delay which is a product of the resistance Rf of 10 kΩ and the capacitor Cf of 1.5 pF,

Time constant=Rf×Cf=15.0 ns (13).

Also, the band fc of each of the I/V converters 12 and 22 is represented as:

fc=1/(2×π×Rf×Cf)=10.6 MHz, and

The phase delay with respect to the detection signal of 1 MHz is represented as:

Phase delay=−tan⁻¹(1/10.6)=−5.4° (14).

Next, FIG. 9A shows the signal waveforms of the phase A signal and the phase B signal in which the fixed phase difference is corrected and FIG. 9B shows the signal waveforms of the phase A signal and the phase B signal in which the fixed phase difference is corrected, where a delay time Δt occurs on the phase B signal. The delay time may occur due to the difference in pattern length between the phase A and the phase B from the light receivers 11 and 21 to the A/D converters 14 and 24, a shift in sampling timing between the A/D converters 14 and 24, and the like. When the difference in pattern length is equal to 2 cm, a delay time Δt of approximately 0.1 ns occurs, whereas a delay time Δt of approximately 1 ns occurs due to a shift in sampling timing between the A/D converters 14 and 24. The delay time Δt is basically a constant value independent of the frequency of a detection signal and may change due to environmental conditions such as temperature, humidity, or the like.

Next, given that the delay time is Δt and the primary delay time constant of each of the I/V converters 12 and 22 is Tc for the phase B signal of which the gain, offset, and fixed phase difference are corrected,

B(t)=V×sin {2πf×(t+Δt)+∠ tan⁻¹(2πf×Tc)} (15)

Here, when 2πf×Tc<<1, i.e., f<<1/(2πTc),

∠ tan⁻¹(2π×Tc) is approximately equal to 2πf×Tc (16)

When Formula (16) is substituted into Formula (15),

B(t)=V×sin {2πf×(t+Δt+Tc)} (17)

Here, when a shift in primary delay time constant of the phase B with respect to the phase A is ΔTc and ΔTc is substituted into Tc in Formula (17),

B′(t)=V×sin {2πf×(t+Δt+ΔTc)} (18),

and the difference in delay time (time difference) Δτ is as follows:

Difference in delay time Δτ=Δt+ΔTc (19)

A phase shift Δφ due to Δτ in the frequency f of a detection signal depending on a moving speed is represented by Formula (18) and Formula (19),

Δφ=2πfΔτ=2πf×(Δt+ΔTc) (20)

Here, a description will be given of an exemplary numeral value of ΔTc. A stray capacitance Co is parasitized on the surroundings of the circuits of the I/V converters 12 and 22 shown in FIG. 8, and a capacitance Co of approximately 1 pF is parasitized depending on a pattern or arrangement of components. Here, given that a capacitance is represented by the summation of the capacitor Cf and the stray capacitance Co,

Cf+Co=1.5+1=2.5 pF

Then, a time constant is represented as follows:

Time constant=Rf×Cf=25.0 ns (21),

The band fc of the I/V converter is represented as follows:

fc=6.4 MHz.

Also, a phase delay with respect to the detection signal of 1 MHz is represented as follows:

Phase delay=−∠ tan⁻¹(1/6.4)=−8.9° (22)

Since the accuracy of the capacitor Cf is within plus or minus 10%, the stray capacitance Co may also vary within plus or minus 10%. Here, given that a capacitance is represented as follows when variations of Cf and Co are +10%:

Cf+Co=2.5×1.1=2.75 pF,

A time constant is represented as follows:

Time constant=Rf×Cf=27.5 ns (23)

Then, the band fc of each of the I/V converters 12 and 22 is represented as follows:

fc=5.79 MHz, and

A phase delay is represented as follows:

Phase delay=−tan⁻¹(1/5.8)=−9.80° (24)

Also, given that a capacitance is represented as follows when variations of Cf and Co are −10%:

Cf+Co=2.5×0.9=2.25 pF, and

A time constant is represented as follows:

Time constant=Rf×Cf=22.5 ns (25)

Then, the band fc of each of the I/V converters 12 and 22 is represented as follows:

fc=7.07 MHz, and

A phase delay is represented as follows:

Phase delay=−tan⁻¹(1/7.07)=−8.05° (26)

The difference in time constant and the difference in phase delay due to variations of Cf and Co using Formulae (23) to (26) are represented as follows:

Difference in time constant=27.5 ns−22.5 ns=5.0 ns (27)

Difference in phase delay=−9.8−(−8.05)=−1.75° (28)

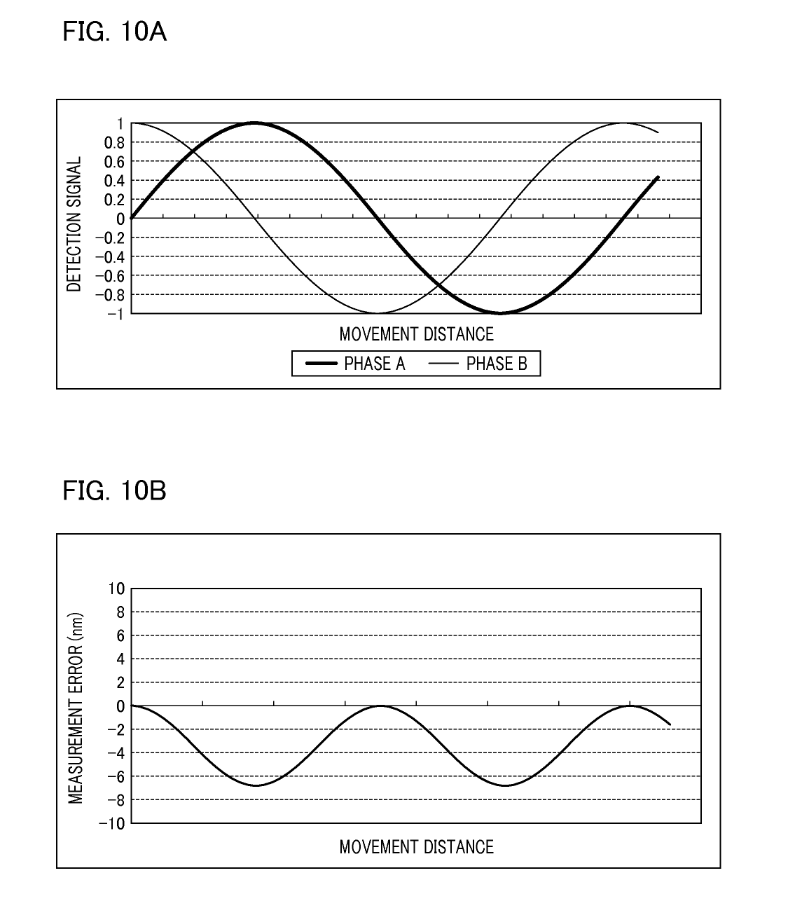

FIG. 10A shows a waveform of a detection signal when the frequency f of each of the phase A signal and the phase B signal is 1 MHz, that is, when Vel is equal to 1 m/s, and FIG. 10B shows a measurement error of a movement distance when the difference in phase delay obtained by Formula (28) is −1.75°. It can be seen that the measurement error has periodical characteristics having the 1/2 period of the detection signal and having an error in the range of from 0 to −6.8 nm. The measurement error due to the difference in phase delay is an extremely large error source when the movement distance is measured with accuracy of approximately 1 nm.

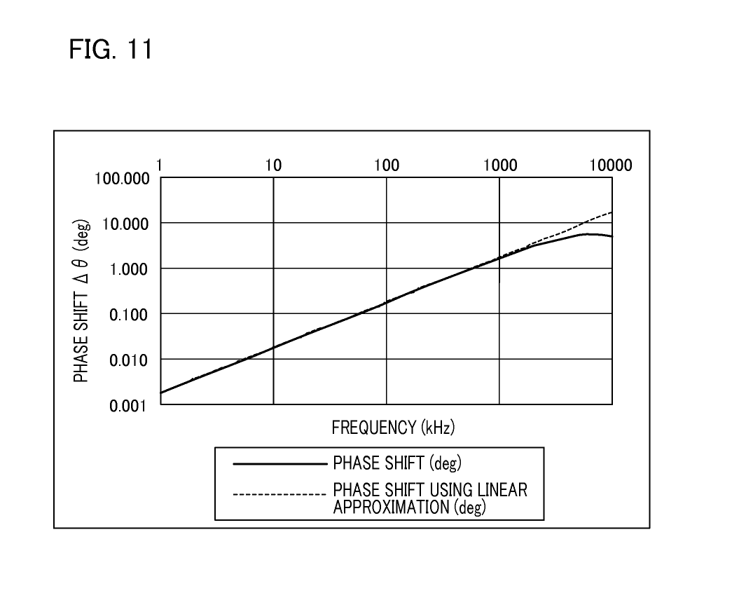

When Δτ is constant in Formulae (18) and (19), the phase shift Δφ due to Δτ with respect to the signal frequency f exhibits characteristics as shown in FIG. 11. The solid line is a line obtained by substituting the values in Formulae (23) and (25) into the left side of Formula (16) and calculating the difference therebetween, and the broken line is a line obtained by calculating the difference using the linear approximate expression on the right side of Formula (16). In this manner, it can be seen that the phase shift Δφ due to Δτ is proportional to the frequency f at a frequency sufficiently lower than the cut-off frequency fc=1/(2πTc), and thus, the lower the frequency, the smaller the phase shift becomes. It can also be seen that, when the signal frequency f approaches the cut-off frequency, the phase shift Δφ is shifted from the linear approximate expression.

Next, a description will be given of the second generator 104 with reference to the difference between the operations performed by the first generator 103 and the second generator 104. In the detection signal phase shift, the fixed phase shift (an error amount of a phase difference) Δθ represented by Formula (2) and the phase shift (a variation amount of a phase difference) Δφ due to the difference Δτ in delay time represented by Formulae (18) to (20) coexist. However, the fixed phase shift A and the phase shift Δφ have different characteristics with respect to the frequency f. The fixed phase shift Δθ is constant without dependence on the frequency f, and the phase shift Δφ is proportional to the frequency f with dependence on the frequency f as described above. Thus, the fixed phase shift Δθ becomes dominant at a low frequency so that the effects of Δφ can be ignored. For example, Δφ is less than 0.02° at a frequency of 10 kHz or less with reference to FIG. 11. In this case, the fixed phase shift Δφ can be detected with accuracy by the first generator 103 so that the fixed phase shift Δθ can be corrected by the correction computation unit 200.

Next, the phase shift Δφ is calculated by the second generator 104 in the state where the effects of Δφ are increased by increasing the frequency f by increasing the moving speed. The multiplier 114, the LPF 124, and the phase difference computation unit 134 that are provided in the second generator 104 shown in FIG. 4 perform the same operation as those provided in the first generator 103. Since the fixed phase shift Δθ is corrected by the correction computation unit 200, the following formula is obtained by the phase difference computation unit 134 using Formulae (7), (18), and (19),

$$\begin{matrix}A ( t ) \times {B}^{′} ( t ) = V \times cos ( ω t ) \times [ V \times sin \{ ω \times ( t + Δτ ) \} ] \\ = - {V}^{2} / 2 \times sin ( - ωΔτ ) + {V}^{2} / 2 \times sin ( 2 ω t + ωΔτ )\end{matrix} \qquad ( 29 )$$

The first term on the right side of Formula (29) is a direct current signal correlated to the difference Δτ in delay time, and the second term is a frequency component twice as high as the frequency f of the detection signal. The direct current component Vdc on the first term is extracted by the LPF 124.

Vdc=−V²/2×sin(−ωΔτ) (30)

sin(ωΔτ)=Vdc/(V²/2) (31)

The phase difference computation unit 134 calculates the variation amount Δφ of a phase difference using Formula (32) or Formula (33).

Δφ=ωΔτ=sin⁻¹{Vdc/(V²/2)} (32)

When Δφ<<1(rad), Δφ is approximately equal to Vdc/(V²/2) (33)

Next, the time difference computation unit 144 calculates the difference Δτ in delay time per unit angular frequency using the signal 42 based on the frequency f of the detection signal depending on the moving speed upon measuring Vdc, and outputs the difference Δτ as the time difference correction signal (difference signal) 40.

Δτ=Δφ/(2×π×f) (34)

As described above, although the difference Δτ in delay time is basically a constant value independent of the frequency of a detection signal and may change due to environmental conditions such as temperature, humidity, or the like. Thus, Δτ is not necessarily measured and calculated at all times but may be measured again only when Δτ may change due to changes in the environmental factors such as temperature, humidity, or the like, changes over time, or the like.

As described above, when a measurement object is in the scanning direction of the reticle stage 4 and the wafer stage 7, the scanning drive speed, i.e., the moving speed is stabilized at the maximum speed during exposure. Also, when a measurement object is in the stepping direction of the wafer stage 7, the stepping drive speed is maximized when the wafer stage 7 moves to the next chip after exposure. Thus, in order to measure the difference Δτ in delay time, optimum conditions are made when the frequency f is the highest at the maximum speed of the scanning drive speed and the stepping drive speed. Also, when the reticle stage 4 or the wafer stage 7 is moving at constant speed during scanning driving or stepping driving, the difference Δτ in delay time is measured. In this case, the difference Δτ in delay time may be measured for each scanning drive and each stepping drive or may also be measured at regular intervals by taking any long time interval for measurement. Also, apart from the exposure operation, a measurement sequence may be provided such that the difference in delay time is calculated by driving each stage at near maximum speed at which the frequency f becomes high and the fixed phase shift is calculated by driving each stage at a low speed at which the frequency f becomes sufficiently low. Furthermore, instead of driving an actual measurement object, the difference Δτ in delay time may also be measured by applying a high-frequency signal which is electrically equivalent to the frequency to be detected at the maximum speed to the light receivers 11 and 21 or the I/V converters 12 and 22.

As described above, it suffices that the measuring apparatus of the present embodiment can calculate the difference in delay time of the devices for outputting the first and the second phase signals. Thus, it suffices that the measuring apparatus of the present embodiment can measure the difference Δτ in delay time due to the difference in pattern length between the phase A and the phase B from the light receivers 11 and 21 to the A/D converters 14 and 24, a shift in sampling timing, the stray capacitance of the I/V converters 12 and 22 or circuits, and the like. The measuring method is not particularly limited. Note that the difference Ai in delay time computed by the time difference computation unit 144 may be stored in a storage unit (not shown).

Next, as shown in FIG. 9B, a description will be given by taking an example in which the phase B signal is delayed in time Δτ with respect to the phase A signal. The difference Δτ in delay time in Formula (34) generated by the second generator 104 of the correction signal generator 100, i.e., the time difference correction signal 40 is input to the timing generator 400. The timing generator 400 regulates the sampling timing of the phase A signal and the phase B signal using the time difference correction signal 40. For example, the phase B signal is delayed in time Δτ as compared with the phase A signal, the sampling of the phase A signal and the phase B signal is not simultaneously performed but the sampling of the phase B signal is delayed by the difference Δτ in delay time. With the aid of this operation, the difference Δτ in delay time is offset by the sampling timing Δτ so as to calibrate a phase shift caused by the difference Δτ in delay time, so that a measurement error due to the difference in delay time can be corrected.

When the difference Δτ in delay time in Formula (27) is equal to 5.0 ns, the difference in delay time can be offset by delaying the sampling timing of the phase B signal by 5 ns. In order to set a measurement error caused by the difference in delay time to 1 nm or less, the sampling timing needs to be adjusted with, for example, a resolution of approximately 0.1 ns. The timing generator 400 is constituted by an FPGA (Field Programmable Gate Array) and can perform timing adjustment with a resolution of approximately 0.1 ns.

While, in the present invention, the difference Δτ in delay time is offset by regulating the sampling timing by the A/D converters 14 and 24, the same performance cannot be obtained by a method for shifting digitalized data by Δτ by setting two identical sampling timings of the A/D converters 14 and 24. For example, in order to shift digitalized data with a resolution of 0.1 ns, at least 10 GHz (0.1 ns period) A/D converters 14 and 24 are required. In this case, digitalized data is computed by the A/D converters 14 and 24 at extreme high speed, which is difficult to be realized.

On the other hand, the regulation of a sampling timing with a resolution of 0.1 ns can be performed by a commercially available FPGA or the like and a desired performance can be obtained by 10 MHz(100 ns period) A/D converters 14 and 24.

As described above, a resolution of sampling timing increases without increasing the sampling frequency of the A/D converters 14 and 24 more than necessary so as to regulate the sampling timing based on the difference ΔT in delay time, so that a phase shift due to the difference in delay time can be corrected.

As described above, the difference Δτ in delay time is basically a constant value independent of the frequency of a detection signal. Thus, a phase shift due to the difference in delay time can be corrected by fixedly shifting sampling timing by Δτ without being affected by the moving speed, i.e., the frequency of the phase A signal and the phase B signal.

When the frequency near or above the cut-off frequency fc of 1/(2nTc) as shown in FIG. 11 is input, a correction error becomes large in the correction signal for the phase shift Δφ. In this case, the difference Δτ in delay time in Formula (34) may be calculated at the moving speed where the frequency is near or above the cut-off frequency and the phase shift ΔT may be calculated by broken line approximation or curve fitting with respect to the frequency f of the detection signal in accordance with the required accuracy.

Next, as shown in FIG. 6, the phase of interference light is calculated by the phase computation unit 301 using the phase A signal 37 and the phase B signal 38 from the correction computation unit 200. A phase may be calculated by tan⁻¹ computation using the ratio between the phase A signal and the phase B signal or may also be determined with reference to the table corresponding to the signal ratio. The distance computation unit 302 calculates the movement distance of the measurement object using the calculated phase signal. For example, when the pitch of a lattice pattern is 1 μm, the movement distance is 1 μm if the phase signal is changed by 2π. Likewise, in the case of measuring a rotation angle, a rotation angle is allocated to the pitch of a lattice pattern. For example, when 360° is divided by 1000, a rotation angle becomes 0.36° if the phase signal is changed by 2π.

Since a noise such as a shot noise of the light receivers 11 and 21 and the I/V converters 12 and 22, a thermal noise, a noise of an OP amplifier, or the like is superimposed on each of the phase A signal 37 and the phase B signal 38, a noise is also included in the value of distance calculated by the distance computation unit 302. The following closed loop filter 303 is configured so as to perform noise reduction. The closed loop filter 303 is constituted by the adder/subtracter 313, and the first integrator 323 and the second integrator 333 which are connected in series. The closed loop filter 303 outputs the output 41 of the second integrator 333 as the position of the measurement object and performs feedback to the adder/subtracter 313. The closed loop filter 303 can not only perform noise reduction but also suppress a deviation from an input signal to zero by feedback configuration, so that the movement distance can be output with higher accuracy. Also, since the output of the second integrator 333 represents a distance, the upstream output, i.e., the output of the first integrator 323 is a signal in accordance with a speed. Based on the pitch of a lattice pattern in Formula (4) using the signal in accordance with a speed, the constant computation unit 343 can calculate the signal 42 based on the frequency f of the detection signal for each of phases A and B. A noise present in the signal 42 is also reduced by the closed loop filter 303, resulting in an accurate output signal.

As described above, the encoder of the present embodiment is used in the reticle stage 4 and the wafer stage 7, so that a phase shift caused by a time difference of output signals from stages which are driven at extreme high speed can be corrected. Consequently, a measurement error is corrected, so that the position of the stage can be measured and controlled with high accuracy. In other words, the encoder for measuring the position of the measurement object compensates variation in phase difference depending on a frequency based on at least one of output signals so that a measurement error caused by a time difference can be compensated.

As described above, according to the present embodiment, a measuring apparatus that compensates a measurement error caused by a time difference between the phases of output signals may be provided.

### (Article Manufacturing Method)

An article manufacturing method according to an embodiment of the present invention is preferred in manufacturing an article such as a micro device such as a semiconductor device or the like, an element or the like having a microstructure, or the like. The article manufacturing method may include a step of forming a pattern (e.g., latent image pattern) on an object (e.g., substrate on which a photosensitive material is coated) using the aforementioned lithography apparatus; and a step of processing (e.g., step of developing) the object on which the latent image pattern has been formed in the previous step. Furthermore, the article manufacturing method may include other known steps (oxidizing, film forming, vapor depositing, doping, flattening, etching, resist peeling, dicing, bonding, packaging, and the like). The device manufacturing method of this embodiment has an advantage, as compared with a conventional device manufacturing method, in at least one of performance, quality, productivity and production cost of a device.

While the present invention has been described with reference to exemplary embodiments, it is to be understood that the invention is not limited to the disclosed exemplary embodiments. For example, in the above embodiments, a description has been given of an exemplary exposure apparatus 1 using ultraviolet light, vacuum ultraviolet light or extreme ultraviolet light as a lithography apparatus. However, the lithography apparatus is not limited thereto but may also be a lithography apparatus including a movable stage for holding an original plate or a substrate. For example, the lithography apparatus may also be a lithography apparatus that performs writing on a substrate with a charged particle beam such as an electron beam to thereby form a pattern on the substrate or may also be an imprint apparatus that forms (molds) an imprint material on a substrate using a mold to thereby form a pattern on the substrate.

This application claims the benefit of Japanese Patent Application No. 2012-172518 filed on Aug. 3, 2012, which is hereby incorporated by reference herein in its entirety.

What is claimed is:

1. A measuring apparatus that measures a position of an object based on a first phase signal and a second phase signal which are different in phase from each other, the measuring apparatus comprising:
a generator configured to generate a difference signal indicating a difference between a delay time of the first phase signal and a delay time of the second phase signal based on a variation amount of a phase difference between the first phase signal and the second phase signal, which corresponds to a frequency of at least one of the first phase signal and the second phase signal, and the frequency; and
a regulator configured to regulate a sampling timing for at least one of the first phase signal and the second phase signal based on the difference signal.

2. The measuring apparatus according to claim 1, wherein the generator is configured to generate the difference signal based on the variation amount of the phase difference and an angular frequency corresponding to the frequency.

3. The measuring apparatus according to claim 1, wherein the generator is configured to regulate an amplitude of the first phase signal based on an error amount of the phase difference independent of the frequency, and to add the first phase signal, whose amplitude has been regulated, to the second phase signal so as to compensate for the error amount.

4. The measuring apparatus according to claim 1, further comprising:
a device configured to obtain the variation amount of the phase difference dependent on the frequency and the error amount of the phase difference independent of the frequency,
wherein the error amount of the phase difference independent of the frequency is obtained prior to the variation amount of the phase difference dependent on the frequency, and the variation amount of the phase difference dependent on the frequency is obtained based on the first phase signal and the second phase signal for which the error amount of the phase difference independent of the frequency has been compensated.

5. The measuring apparatus according to claim 4, wherein the frequency at which the variation amount of the phase difference dependent on the frequency is obtained is higher than the frequency at which the error amount of the phase difference independent of the frequency is obtained.

6. The measuring apparatus according to claim 1, further comprising:
a scale on which elements for generating the first phase signal and the second phase signal are arranged with an interval,
wherein the frequency is obtained based on a moving speed of the object and the interval.

7. The measuring apparatus according to claim 1, further comprising:
an output device configured to output the position of the object based on the first phase signal and the second phase signal,
wherein the output device includes a closed-loop filter including a first integrator and a second integrator in series, and is configured to output the position of the object via the closed-loop filter.

8. The measuring apparatus according to claim 7, further comprising:
a device configured to obtain the frequency based on an output of the first integrator.

9. The measuring apparatus according to claim 4, wherein the variation amount of the phase difference dependent on the frequency is obtained based on the first phase signal and the second phase signal which are obtained in a case where the object moves at a constant velocity.

10. The measuring apparatus according to claim 9, wherein the variation amount of the phase difference dependent on the frequency is obtained based on a direct current component of a signal obtained by multiplying the first phase signal by the second phase signal.

11. A lithography apparatus that forms a pattern on a substrate, the lithography apparatus comprising:
a holder configured to hold an original or the substrate, and to be moved; and
a measuring apparatus configured to measure a position of the holder,
wherein the measuring apparatus measures the position of the holder based on a first phase signal and a second phase signal which are different in phase from each other, the measuring apparatus including:
a generator configured to generate a difference signal indicating a difference between a delay time of the first phase signal and a delay time of the second phase signal based on a variation amount of a phase difference between the first phase signal and the second phase signal, which corresponds to a frequency of at least one of the first phase signal and the second phase signal, and the frequency; and
a regulator configured to regulate a sampling timing for at least one of the first phase signal and the second phase signal based on the difference signal.

12. A method of manufacturing an article, the method comprising:
forming a pattern on a substrate using a lithography apparatus; and
processing the substrate, on which the pattern has been formed, to manufacture the article,
wherein the lithography apparatus includes:
a holder configured to hold an original or the substrate, and to be moved; and
a measuring apparatus configured to measure a position of the holder,
wherein the measuring apparatus measures the position of the holder based on a first phase signal and a second phase signal which are different in phase from each other, the measuring apparatus including:
a generator configured to generate a difference signal indicating a difference between a delay time of the first phase signal and a delay time of the second phase signal based on a variation amount of a phase difference between the first phase signal and the second phase signal, which corresponds to a frequency of at least one of the first phase signal and the second phase signal, and the frequency; and
a regulator configured to regulate a sampling timing for at least one of the first phase signal and the second phase signal based on the difference signal.
